(19) United States
(12) Patent Application Publication
(10) Pub. No.: US 2008/0148583 A1
(43) Pub. Date: Jun. 26, 2008

(54) Measring Stick with Stop

(76) Inventor: Dieter Sinn, Schwegenheim (DE)

Correspondence Address: Martin Geissler;Mcgrath, Geissler Olds & Richardson, P O Box 1364, Fairfax, VA, 22030, US

(21) Appl. No.: 11/660,941

(22) PCT Filed: Aug. 22, 2005
(86) PCT No.: PCT/DE2005/001480

§ 371 Date: Sep. 20, 2007

(30) Foreign Application Priority Data
Aug. 23, 2004 (DE) 10 2004 040 838.6

(51) Int. Cl. G01B 3/06

(52) U.S. Cl. 33/490

(57) ABSTRACT

The invention relates to a measuring stick, particularly a folding measuring stick, having a stop (1) that, at one end of the measuring stick (7), extends transversal to the longitudinal axis of the measuring stick (7). The inventive measuring stick is characterized in that a magnetic element (2a, 2b) is placed at the end of the measuring stick (7), and the stop (1) is formed by an element (1) made of a ferromagnetic material.

The invention relates to a measuring stick, in particular a folding measuring stick according to the preamble of claim 1, with a stop which extends transverse to the longitudinal axis of the measuring stick at one end of the measuring stick.

Measuring sticks, in particular folding measuring sticks, are possibly the most frequently used length-measuring apparatuses in industry. They can be used to determine geometric dimensions in a simple manner and with a sufficient degree of accuracy. However, the problem often occurs that the object which is to be measured does not have a stop against which the end of the measuring stick can be positioned. Therefore, a stop is alternatively often formed using an object which happens to be located in the vicinity or the user uses his fingers.

This disadvantage is not present in the case of tape measures since these routinely have a stop which is intended to prevent the tape measure rolling up to such an extent that the end of the tape measure enters the housing. By virtue of this stop, the end of the tape measure can be easily placed, for example, on an edge of an object to be measured, for example a plate.

However, it is not known to provide a stop of this type for measuring sticks or folding measuring sticks. An earlier patent application by the patent applicant, which application which was not published before the priority date, therefore proposes forming a measuring stick, in particular a folding measuring stick, such that a stop is provided which is arranged perpendicular in relation to the stick, offset in relation to the longitudinal axis of the stick and whose perpendicular projection from the measuring stick coincides with the start of a scale.

Placing a stop of this type against, for example, the edge surface of a plate to be measured ensures that the start of the scale is exactly aligned with the edge of the plate.

Whereas it would be possible to firmly attach a stop of this type on that side of the measuring stick which faces away from the scale, the stop may, however, also be produced by moving a stop element which is connected to the measuring stick. In particular, the stop element can be folded and/or pulled or pushed out of the stick. Therefore, a stop element which can be folded out can, for example, form an end piece of the measuring stick.

The stop element expediently adjoins the surface of the measuring stick such that they are flush, it also being possible for said stop element to be recessed in the measuring stick. An elongate stop element which can be pulled out of a recess in an end face of the measuring stick, for example against the force of a spring, can be moved in the transverse direction after it is pulled out, with said elongate stop element resting in a transverse fashion against the end face. The scale can begin directly at the measuring stick end. Although a measuring stick of this type also has great advantages over the measuring sticks already known up until that point, it is still not optimal.

The object of the invention is to form a measuring stick of the type mentioned in the introduction in such a way that it can be handled in a simple and very reliable manner.

This object is achieved by the features of the characterizing part of claim 1. Advantageous developments of the invention can be found in the subclaims.

The invention provides a measuring stick, in particular a folding measuring stick, with a stop which extends transverse to the longitudinal axis of the measuring stick at one end of the measuring stick, characterized in that a magnetic element is arranged at the end of the measuring stick, and the stop is formed by an element which is made of a ferromagnetic material.

On account of a magnetic element being arranged at the end of the measuring stick at which the stop extends transverse to the longitudinal axis of the measuring stick, and the stop being formed by an element which is made of a ferromagnetic material, firstly a very accurate stop and secondly a very reliable stop is obtained. The latter means that the stop is highly unsusceptible to damage. Since the stop element is connected to the measuring stick only by means of a magnetic force, it cannot bend or break. If the forces which act on the stop element from the outside exceed the magnetic forces with which the stop element is held on the measuring stick, the stop element yields. However, since the magnetic force continues to act on the stop element, the stop element is advantageously not separated from the measuring stick when said stop element yields, in which case it could become lost, but rather adheres to the measuring stick in another undefined position. Thereafter, it would only need to be returned to its correct position, after which the measuring stick would again be ready for use in an unchanged form.

An embodiment of the invention which has been found to be very advantageous is one in which the magnetic element is in the form of a permanent magnet and is arranged in a carrier element which is advantageously composed of a non-magnetic material, for example plastic or aluminum. Forming the magnetic element as a permanent magnet means that standard elements can be used, and this has a very advantageous effect on costs. The arrangement of the magnetic element in a carrier element has the advantage that the magnetic element can be connected to the measuring stick in a very simple manner. For example, the carrier element can be formed such that it is mounted, for example, on the measuring stick, as a result of which a measuring stick can be modified at a later date in a manner according to the invention. The carrier element could be provided as a separate component.

In the last-mentioned embodiment, it is particularly advantageous if the magnetic element comprises a plurality of permanent magnets which are arranged on a yoke which is made of ferromagnetic material. The yoke is advantageously composed of a material with a low magnetic resistance. On account of the yoke, the magnetic element advantageously has a high magnetic force. In particular, it is possible to arrange the permanent magnets such that their magnetic field strengths are added together. In the case of two permanent magnets, this means that one magnet is connected to the yoke by means of its north pole and the other magnet is connected to the yoke by means of its south pole.

On account of the carrier element being composed of a non-magnetic material, for example plastic or aluminum, the carrier element can be produced from conventional profile strips in a simple manner. Since said carrier element is composed of a non-magnetic material, it has virtually no effect on the action of the magnetic element.

A very advantageous embodiment of the invention is one in which a holding means which is in the form of a receptacle and in which the stop element can be arranged is provided. On account of this, the stop element is always located in the measuring stick, with the result that it can be put into use in a simple and quick manner.

A very advantageous embodiment of the invention has proven to be one in which the holding means has a recess in which the stop element can be arranged. The stop element is securely stored on account of the recess. Therefore, no special care needs to be taken of the stop element during normal use of the measuring stick.

It is particularly advantageous if the receptacle has at least one holding magnet. The stop element is likewise stored in a very secure and reliable manner on account of the holding magnet.

Further details, features and advantages of the present invention can be found in the following description of one particular exemplary embodiment with reference to the drawing, in which

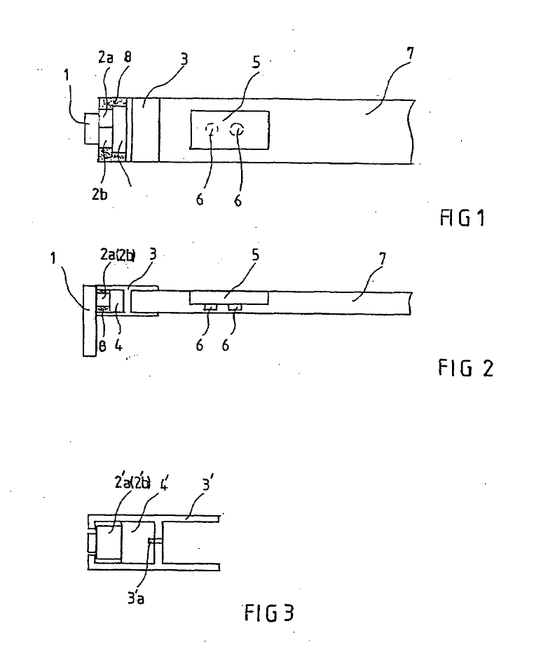

FIG. 1 shows a sectional plan view of one end of a measuring stick,

FIG. 2 shows a sectional side view of the end of the measuring stick illustrated in FIG. 1, and

FIG. 3 shows a sectional side view of a further embodiment of a carrier element.

As can be seen in FIGS. 1 and 2, a carrier element 3 is arranged on a measuring stick 7 at one end of the measuring stick 7. The carrier element 3 is an H-shaped aluminum profile and is pushed onto the measuring stick 7. In order to be fixed to the measuring stick 7, said carrier element is adhesively bonded or riveted to the measuring stick 7.

A yoke 4 which is composed of iron is fitted on the crosspiece of the H-profile 2 at that end which faces away from the measuring stick 7. The yoke 4 is a bar of rectangular cross section. Two cylindrical permanent magnets 2a, 2b are arranged on the yoke 4. The dimensions of the yoke 4 and of the permanent magnets 2a, 2b are such that the faces of the permanent magnets 2a, 2b which face away from the yoke 4 are aligned with the upper edges of the H-profile 3. The alignment line corresponds to the reference point of the measuring stick 7. The yoke 4 and the permanent magnets 2a, 2b are fixed in the H-profile 3 by means of an encapsulation compound 8. The permanent magnets 2a, 2b are arranged such that the north pole of the upper permanent magnet 2a is connected to the yoke 4, whereas the south pole of the lower permanent magnet 2b is connected to the yoke 4.

A small plate 1 which is composed of iron and forms a stop is bonded to the faces of the magnets 2a, 2b which face away from the yoke 4. Since the small plate 1 is connected to the measuring stick 7 only by means of a magnetic force, it can be detached from the measuring stick 7 in a simple manner. In particular, it can be bent away from the measuring stick 7 without either the measuring stick 7 or the small plate 1 being damaged.

A recess 5 whose geometric dimensions correspond approximately to the geometric dimensions of the small plate 1 is formed in the measuring stick 7. As a result, the small plate 1 can be arranged in the recess 5. In order to securely hold the small plate 1 in the recess 5, two permanent magnets 6 are arranged in the measuring stick 7 beneath the recess 5. As a result, the small plate 1 is reliably held in the recess 5.

In the embodiment of the carrier element 3′ which is illustrated in FIG. 3, the yoke 4′ and the permanent magnets 2a′, 2b′ are not encapsulated by the profile 3′. In addition, the profile 3′ is not in the form of an H-profile but, on one side, is in the form of a box with a slot and on the other side is in the form of a U-profile. Furthermore, the magnets 2a, 2b are not cylindrical but have a T-shaped longitudinal cross section. The vertical part of the T of the permanent magnets 2a′, 2b′ extends through the slot. As a result, the permanent magnets 2a′, 2b′ are prevented from falling out. They can only enter the profile sideways. The yoke 4′ can likewise only enter the profile 3′ sideways. The yoke 4′ is prevented from shifting sideways by means of a pin 3a′. Since the permanent magnets 2a′, 2b′ are firmly bonded to the yoke 4′ on account of their magnetic forces, they are therefore likewise prevented from sliding out of the profile 3′ sideways. As in the embodiment illustrated in FIGS. 1 and 2, the carrier element 3′ is pushed onto the measuring stick 7 and fixed by means of adhesive bonding or riveting.

1. A measuring stick comprising:
a stop which extends transverse to a longitudinal axis of the measuring stick at one end of the measuring stick; and
a magnetic element arranged at an end of the measuring stick,
wherein the stop is formed by an element which is made of a ferromagnetic material.

2. The measuring stick as claimed in claim 1, wherein the magnetic element is in the form of a permanent magnet and is arranged in a carrier element.

3. The measuring stick as claimed in claim 1, wherein the magnetic element comprises at least two permanent magnets which are arranged on a yoke which is made of ferromagnetic material.

4. The measuring stick as claimed in claim 3, wherein the permanent magnets are arranged such that the magnetic field strengths are added together.

5. The measuring stick as claimed in claim 1, further comprising a receptacle in which the stop element is arranged.

6. The measuring stick as claimed in claim 5, wherein the receptacle has a recess in which the stop element is arranged.

7. The measuring stick as claimed in claim 5, wherein the receptacle has holding magnets.

8. The measuring stick as claim in claim 1, wherein the measuring stick is a folding measuring stick.
